(19) United States
(12) Patent Application Publication
(10) Pub. No.: US 2024/0214011 A1
(43) Pub. Date: Jun. 27, 2024

(54) SYSTEMS AND METHODS OF THERMAL MANAGEMENT

(71) Applicant: Meta Platforms Technologies, LLC, Menlo Park, CA (US)

(72) Inventors: Siddharth Ray, Cupertino, CA (US); Shivank Nayak, Milpitas, CA (US); Dong Zheng, Saratoga, CA (US); Amit Shukla, Fremont, CA (US)

(21) Appl. No.: 18/085,652

(22) Filed: Dec. 21, 2022

(51) Int. Cl. H04B 1/036; G06F 1/20; H04W 28/20

(52) U.S. Cl. CPC H04B 1/036; G06F 1/206; H04W 28/20

(57) ABSTRACT

Disclosed herein are aspects related to a device that can include a wireless communication interface and one or more processors. The wireless communication interface can establish at least one of (i) a first link with a first remote device or (ii) a second link with a second remote device. The one or more processors can control operation of the at least one wireless communication interface according to: (i) temperature data of at least one of the device or first remote device; and (ii) at least one of (a) power data of at least one of the first device or the second device or (b) at least one of capacity or throughput of at least one of the first link or the second link.

### FIELD OF DISCLOSURE

The present disclosure is generally related to facilitating wireless communication, including but not limited to systems and methods for thermal management.

### BACKGROUND

Developments in computing devices and communication devices have prompted growth in wearable technology. Wearable devices may integrate various components in a compact form, such that the wearable devices can be portable yet perform complex processes. For example, a wearable device may be a smart watch that may access content over the network, and may control or communicate with other computing devices, etc. For example, a wearable device may be a head mounted display (HMD) that may present artificial reality (e.g., virtual reality, augmented reality, extended reality, mixed reality, etc.).

### SUMMARY

Various implementations disclosed herein are related to a device that can include a wireless communication interface and one or more processors. The wireless communication interface can establish at least one of (i) a first link with a first remote device or (ii) a second link with a second remote device. The one or more processors can control operation of the at least one wireless communication interface according to: (i) temperature data of at least one of the device or first remote device; and (ii) at least one of (a) power data of at least one of the first device or the second device or (b) at least one of capacity or throughput of at least one of the first link or the second link.

In some implementations, the one or more processors can control operation of the at least one wireless communication interface according to application data of one or more applications that transmit or receive data packets for communication over the at least one of the first link or the second link. In some implementations, the one or more processors control operation of the at least one wireless communication interface by: determining a thermal state, of at least one of the device or the first remote device, according to the temperature data and the at least one of capacity or throughput of the at least one of the first link or the second link, and by determining an adjustment to operation of the at least one wireless communication interface responsive to evaluating a mitigation criteria according to the thermal state.

In some implementations, the one or more processors can control the operation of the at least one wireless communication interface by reducing resource usage of the at least one wireless communication interface. The reduction of resource usage can correspond to a reduction of at least one of power usage or throughput.

In some implementations, the first remote device comprises a display device, and the second remote device comprises a network access point. In some implementations, the one or more processors can control operation of the at least one wireless communication interface by selecting, from a data structure associating a plurality of mitigation states with values of data, a particular mitigation state of the plurality of mitigation states according to (i) the temperature data and/or (ii) the at least one of (a) the power data or (b) the at least one of capacity or throughput, and reducing resource usage of the at least one wireless communication interface according to the selected mitigation state.

Various implementations disclosed herein relate to a method. The method can include establishing, by at least one wireless communication interface, at least one of (i) a first link with a first remote device or (ii) a second link with a second remote device. The method can include controlling, by one or more processors, operation of the at least one wireless communication interface according to: (i) temperature data of at least one of the device or first remote device; and (ii) at least one of (a) power data of at least one of the first device or the second device or (b) at least one of capacity or throughput of at least one of the first link or the second link.

In some implementations, the method includes controlling, by the one or more processors, operation of the at least one wireless communication interface according to application data of one or more applications that transmit or receive data packets for communication over the at least one of the first link or the second link. In some implementations, the method includes controlling, by the one or more processors, operation of the at least one wireless communication interface by: determining a thermal state, of at least one of the device or the first remote device, according to the temperature data and the at least one of capacity or throughput of the at least one of the first link or the second link, and determining an adjustment to operation of the at least one wireless communication interface responsive to evaluating a mitigation criteria according to the thermal state.

In some implementations, the method includes controlling, by the one or more processors, operation of the at least one wireless communication interface by reducing resource usage of the at least one wireless communication interface. The reduction of resource usage can correspond to a reduction of at least one of power usage or throughput.

In some implementations, the first remote device comprises a display device, and the second remote device comprises a network access point. In some implementations, the method includes controlling, by the one or more processors, operation of the at least one wireless communication interface by: selecting, from a data structure associating a plurality of mitigation states with values of data, a particular mitigation state of the plurality of mitigation states according to (i) the temperature data and (ii) the at least one of (a) the power data or (b) the at least one of capacity or throughput, and reducing resource usage of the at least one wireless communication interface according to the selected mitigation state.

Various implementations are disclosed that relate to a non-transitory computer readable medium, which can store instructions that when executed by one or more processors of a device, cause the one or more processors to control operation of at least one wireless communication interface, the at least one wireless communication interface operating at least one of (i) a first link with a first remote device or (ii) a second link with a second remote device, the control performed according to: (i) temperature data of at least one of the device or the first remote device; and (ii) at least one of (a) power data of at least one of the first device or the second device or (b) at least one of capacity or throughput of at least one of the first link or the second link.

In some implementations, the instructions cause the one or more processors to control operation of the at least one wireless communication interface according to application data of one or more applications that transmit or receive data packets for communication over the at least one of the first link or the second link. In some implementations, the instructions cause the one or more processors to control operation of the at least one wireless communication interface by: determining a thermal state, of at least one of the device or the first remote device, according to the temperature data and the at least one of capacity or throughput of the at least one of the first link or the second link, and/or determining an adjustment to operation of the at least one wireless communication interface responsive to evaluating a mitigation criteria according to the thermal state.

In some implementations, the instructions cause the one or more processors to control operation of the at least one wireless communication interface by reducing resource usage of the at least one wireless communication interface. The reduction of resource usage can correspond to a reduction of at least one of power usage or throughput.

In some implementations, the first remote device comprises a display device, and the second remote device comprises a network access point. In some implementations, the instructions cause the one or more processors to control operation of the at least one wireless communication interface by: selecting, from a data structure associating a plurality of mitigation states with values of data, a particular mitigation state of the plurality of mitigation states according to (i) the temperature data and (ii) the at least one of (a) the power data or (b) the at least one of capacity or throughput, and/or reducing resource usage of the at least one wireless communication interface according to the selected mitigation state.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including wearable devices, according to an example implementation of the present disclosure.

FIG. 2 is a diagram of a system for thermal management of at least one device, according to an example implementation of the present disclosure.

FIG. 3 is a diagram of a system for thermal management of a plurality of devices, according to an example implementation of the present disclosure.

FIG. 4 is a diagram of a wearable device, according to an example implementation of the present disclosure.

FIG. 5 is a diagram showing a perspective view of a head wearable display, according to an example implementation of the present disclosure.

FIG. 6A is a diagram showing a perspective view of a wearable device including a computing device attached to a cradle, according to an example implementation of the present disclosure.

FIG. 6B is a diagram showing a perspective view of a wearable device including a computing device detached from a cradle, according to an example implementation of the present disclosure.

FIG. 7 is a flowchart showing a method of thermal management, according to an example implementation of the present disclosure.

FIG. 8 is a block diagram showing a computing environment of a wearable device, according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Disclosed herein are implementations related to systems and methods that can perform temperature condition and/or power-condition related management of devices that include wireless communication interfaces. Devices that perform wireless communications can have their performance affected by factors such as the temperature of the devices or components of the devices, the available capacity (e.g., remaining/available power level) of a power supply (e.g., battery) of the devices, and the power demands of applications and other components of the devices that are in use, including transmission power demands relating to throughput and/or capacity of the wireless communication interfaces. For instance, a device may perform compute operations and can communicate data using a first uplink and a first downlink with a first device, such as a wearable device (e.g., HMD), that is to present artificial reality using the data. The device may also communicate data with a second device, such as an access point or base station connected with a network, over a second uplink and a second downlink. Allocating at least some compute operations to the device and at least some display operations to the first device can enable the first device to have a smaller and/or more comfortable form factor.

The compute, display, and communication operations performed by the device and first device (and second device) can use/consume energy/power of power supplies of the device and first device. In addition, these operations can result in heat generation by the power supplies and other components of the devices. Various such factors (e.g., thermal stress and/or power stress factors) can affect performance of the devices, including reducing on time of the devices (e.g., by causing the energy stored in the power supplies to be used/reduced more rapidly), causing thermal stress, or affecting wear on the components of the devices.

Systems and methods in accordance with the present disclosure can apply mitigation actions to operation of components of the devices, including the wireless communications interfaces, that adjust the operation of the these components to reduce or avoid the thermal stress and/or power stress effects on performance. For example, systems and methods of thermal management can be implemented for devices that use wireless communication interfaces including cellular and WiFi interfaces. The system can control operation of the wireless communications interface according to signals indicating at least one of current or expected temperature/heat generation, battery state, power usage, application information, interface capacity, or interface throughput. For example, the system can cause the wireless communications interface to perform particular mitigation actions, such as to operate in particular modes, according to various such signals and application scenarios. The mitigation actions can include actions that are expected to reduce power usage and/or heat generation, such as antenna/antenna chain reduction, SCC reduction, out-of-service (OOS) scan reduction, disabling NSA, reducing or modifying bandwidth, reducing transmit time budgets, and/or reducing power.

The system can prioritize mitigation actions with respect to higher/lower mitigation targets to preserve performance (e.g., for specific applications). For example, the system can determine a mitigation level or state according to the signals (which may be distinct levels for power and thermal signals for each device) and can map the mitigation level to appropriate actions of relatively greater or lesser expected effects on performance. The system can account for latency/jitter requirements associated with particular actions, such as to limit actions to those with relatively lesser effects/impact on performance while applications that have real-time communication latency/jitter requirements are operating.

In an example, the system can be implemented to perform or enable thermal and power management for a compute device (e.g., stage/console device) and display device (e.g., HMD), where the compute device is communicating with an access point using at least one first link, and with the display device using at least one second link. The system can determine mitigation commands for the respective wireless communications interfaces of the compute device and the display device that operate the respective at least one first link and at least one second link according to power, temperature, and/or capacity/throughput signals of at least one of the compute device or the display device.

Although various implementations disclosed herein are provided with respect to wearable devices, principles disclosed herein can be applied to any other type of devices such as handheld, mobile or small form factor devices (e.g., smart phones, tablet computers, laptops, etc.).

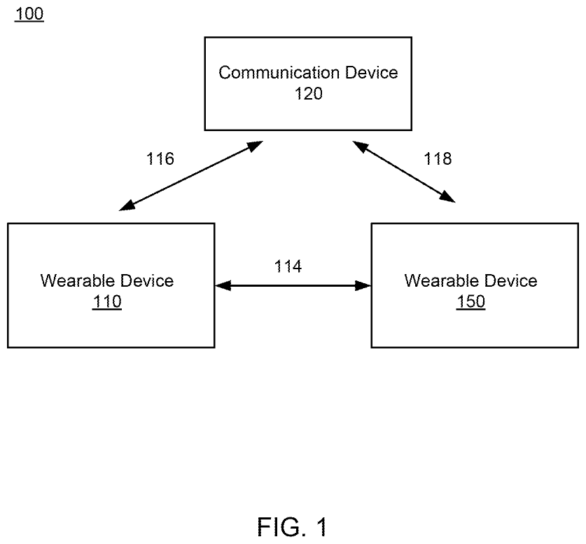

FIG. 1 is a block diagram of an example system 100. In some implementations, the system 100 includes a communication device 120, a device 110 (e.g., wearable device), and a device 150 (e.g., wearable device). The wearable device 110 may be a smart watch, and the wearable device 150 may be a head wearable device (HWD) 150. While described as a wearable device 110, the wearable device 110 may also be a console or other device that may be portable in some instances and may or may not be worn by a user. The communication device 120 may be an access point or any other communication device. The HWD 150 may be referred to as, include, or be part of a head mounted display (HMD), head mounted device (HMD), head worn display (HWD) or head worn device (HWD). The wearable device 110 and the HWD 150 may communicate with each other through a communication link 114. The wearable device 110 and the communication device 120 may communicate with each other through a communication link 116, and the wearable device 150 and the communication device 120 may communicate with each other through a communication link 118. Through the wireless links 116, 118, the wearable devices 110, 150 may access content (e.g., text, image, audio, video, etc.) from other devices. The communication links 114, 116, 118 may be wireless links (e.g., cellular link, Wi-Fi link, Bluetooth link, 60 GHz link, ultra wideband link, etc.). The communication links 114, 116, 118 may be based on the same protocol or different protocols. For example, the communication links 116, 118 may conform to the 3G, 4G, 5G, LTE, 60 GHz protocol, where the communication link 114 may conform to the Wi-Fi link, Bluetooth, etc. In some implementations, the system 100 includes more, fewer, or different components than shown in FIG. 1.

In one aspect, the wearable device 110 and the wearable device 150 may operate together to provide/support artificial reality for a user. In one example, the wearable device 150 may detect a location and an orientation of the wearable device 150, and generate a sensor measurement indicating the detected location and orientation of the wearable device 150. The wearable device 150 may transmit the sensor measurement to the wearable device 110 through the communication link 114. The wearable device 110 may receive the sensor measurement, and may generate or determine a view of the artificial reality corresponding to the detected location and orientation of the wearable device 150. The wearable device 110 may generate image data of the determined view of the artificial reality, and transmit the image data to the wearable device 150 through the communication link 114. The HWD 150 may receive the image data, and can present an image of the artificial reality to a user according to the image data. In one aspect, the process of detecting the location and the orientation of the HWD 150, and rendering the image to the user should be performed within a frame time (e.g., 11 ms or 16 ms). Any latency between a movement of the user wearing the HWD and an image displayed corresponding to the user movement can cause judder, which may result in motion sickness and can degrade the user experience.

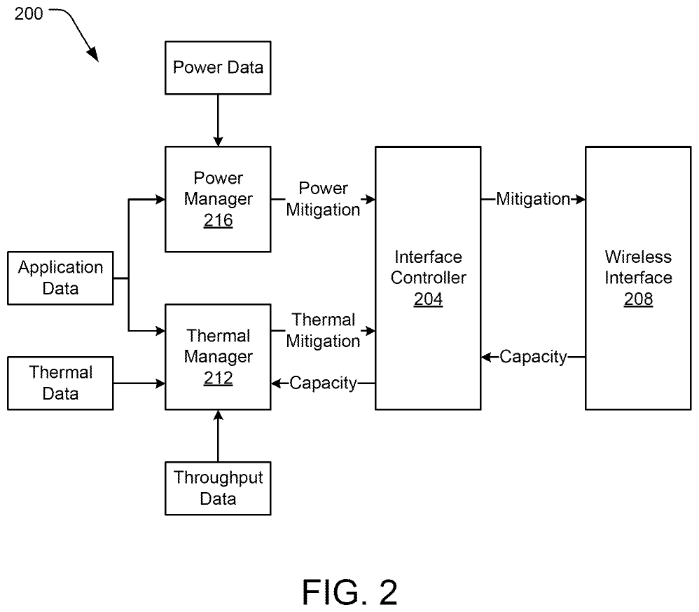

FIG. 2 depicts an example of a system 200, according to an example implementation of the present disclosure. The system 200 can be implemented by various devices described herein, including but not limited to one or more of the devices 110, 120, 150. For example the system 200 can be implemented by the device 110 to perform compute operations to provide data used by the device 150 for presenting artificial reality (e.g., XR, AR, VR), including while the device 110 is communicating wirelessly (e.g., using cellular, Bluetooth, and/or WiFi communications) with the device 120 (as an access point) and the device 150. Various components of system 200 that are depicted in FIG. 2 as distinct components, such as thermal manager 212 and power manager 216, may be implemented using the same or other components in various combinations.

In brief overview, the system 200 can include an interface controller 204 and at least wireless communications interface 208. The interface controller 204 can include one or more rules, heuristics, models, functions, mappings, algorithms, or other operators to perform operations such as processing data such as temperature, power/energy, capacity, and/or throughput data to apply mitigation actions to operation of wireless communication interfaces 208. The wireless communication interfaces 208 can include, for example, one or more cellular, WiFi, UWB, or Bluetooth communications interfaces.

Referring further to FIG. 2, the system 200 can include at least one thermal manager 212. The thermal manager 212 can include one or more rules, heuristics, models, functions, mappings, algorithms, or other operators to perform operations such as processing thermal data, throughput data, and/or capacity data to determine a thermal mitigation according to the processing. The thermal manager 212 can provide the determined thermal mitigation to the interface controller 204. The thermal manager 212 can determine thermal mitigations for operation of each particular wireless communication interface 208 (e.g., with respect to operation of cellular, WiFi, and/or Bluetooth interfaces) or links (e.g., uplink or downlink) of the wireless communication interfaces, or for various combinations of wireless communication interfaces 208.

As depicted in FIG. 2, the thermal manager 212 can receive thermal data. The thermal data can be received from a sensor such as a temperature sensor or heat sensor (not shown). The thermal data can be received from a sensor coupled with one or more components of the devices 110, 150, such as the wireless communication interfaces 208 or power supplies of the devices 110. The thermal data can be received from a device monitor, such as a device health manager, of the devices 110, 150 that are coupled with the respective sensors. The thermal data can include, for example, temperature, change of temperature (e.g., rate of change of temperature), or heat data.

The thermal data can be received as a particular thermal state (e.g., stress level) of a plurality of thermal states, or the thermal manager 212 can determine, according to the thermal data, the particular thermal state. For example, the thermal manager 212 can have a data structure indicating a plurality of thermal states corresponding to varying levels of thermal stress (e.g., none, light, moderate, or high thermal stress, among other classifications that may have greater or fewer thermal states or levels), and can determine the particular thermal state to correspond with one of the plurality of thermal states (e.g., to correspond with one of the levels of thermal stress). The thermal manager 212 can determine the thermal state according to the thermal data by comparing the thermal data with one or more thresholds; for example, the data structure can include a plurality of temperature thresholds corresponding to the plurality of thermal states, and the thermal manager 212 can determine the thermal state by comparing temperature data of the thermal data with at least one temperature threshold of the plurality of temperature thresholds.

The thermal manager 212 can receive application data. The application data can include an identifier of one or more applications, such as applications that are being operated (e.g., executing on the device and/or the first device referenced herein). The applications can include, for example, applications for providing calling (e.g., phone, video calls), messaging, streaming, live streaming, and/or artificial reality information or content. For example, the applications can include one or more of an augmented calling application that facilitates a live calling experience (and which may include augmented reality display data presented together with data from one or more image capture devices), an augmented messaging application that facilitates a live stream experience, an asynchronous augmented message application, and a virtual experience application. The application data can include an indication of a timing criteria associated with a respective application. For example, certain applications may have timing criteria related to latency/jitter effects (e.g., applications may be sensitive to latency or jitter), such as for presenting audio, text, speech, and/or display data at a particular rate or in a particular synchronization; other applications may not have to meet such timing criteria.

In some implementations, the application data indicates (or the thermal manager 212 can determine) a throughput value associated with operation of the application, such as at least one of an uplink or a downlink throughput, which may correspond to communication between the device 110 and at least one of the device 120 or the device 150. For example, for a particular application, the application data can indicate (or the thermal manager 212 can determine, such as by parsing a lookup table or other data structure) expected or actual throughput values such as uplink or downlink data rates for uplink and/or downlink connections between the device 110 and the device 120, or between the device 110 and the device 150.

The thermal manager 212 can receive an indication of a throughput of the wireless communication interface 208. The throughput can be an amount or rate of data (or network packets) of at least one of data (or network packets) transmitted by (e.g., uplink) the wireless communication interface 208 or data (or network packets) received by (e.g., downlink) the wireless communication interface 208. The indication can be an estimate of throughput at a particular point in time or averaged over a plurality of time points, such as to provide a real-time estimate of throughput. The indication of throughput can be received from a traffic statistic monitor of the wireless communication interface 208.

The thermal manager 212 can receive an indication of capacity of the wireless communication interface 208. The capacity can include an absolute or relative proportion of total capacity, such as total capable throughput (e.g., as an amount or rate of data or network packets), of the wireless communication interface 208. The indication of capacity can correspond to at least one of a data transmission (e.g., uplink) or data reception (e.g., downlink) capacity. The capacity can be received/indicated from firmware of the wireless communication interface 208. The capacity can be received/indicated via the interface controller 204.

In some implementations, the thermal manager 212 can determine (e.g., select) a thermal mitigation according to at least one of the application data, the thermal data, the throughput, or the capacity. The thermal manager 212 can determine the thermal mitigation to include at least one of a level of mitigation (e.g., modification or reduction of resource usage by the wireless communication interface 208) or a particular action for mitigation (e.g., particular action to modify or reduce resource usage). In some implementations, the thermal manager 212 determines one or more composite metrics according to the at least one of the application data, the thermal data, the throughput, or the capacity. For example, the thermal manager 212 can determine a utilization metric according to the throughput and the capacity (e.g., throughput divided by capacity), and can determine the thermal mitigation according to at least one of the application data, the thermal data, or the utilization metric.

The thermal manager 212 can determine the thermal mitigation by applying one or more rules, thresholds, models, lookup tables, algorithms, heuristics, or other operations to the at least one of the application data, the thermal data, the throughput, or the capacity. In some implementations, the thermal manager 212 determines the thermal mitigation by evaluating the at least one of the application data, the thermal data, the throughput, or the capacity relative to one or more respective thresholds (which may be maintained in a data structure such as a lookup table). For example, the thermal manager 212 can select the thermal mitigation from a plurality of thermal mitigations by comparing the application data, thermal data, throughput, and/or capacity with respective thresholds to identify a particular thermal mitigation that matches values (or ranges of values) represented by the respective thresholds. Table 1 below provides an example of a data structure that the thermal manager 212 can implement to determine the thermal mitigation as a thermal mitigation level. The thermal mitigation level values provided in Table 1 are examples and can be configured during various processes (and at greater or less degrees of granularity), including but not limited to during manufacture, testing, calibration, before delivery to one or more end users, or after delivery to one or more end users (e.g., via on-board updating based on tracked performance data, via software or firmware updates, etc.). In the example of Table 1, higher thermal mitigation levels can correspond to mitigation actions that can be expected to increasingly reduce resource usage, such as to have greater effects for reducing thermal stress.

TABLE 1

| | | Thermal | | | Thermal | | | Thermal | | |
|---|---|---|---|---|---|---|---|---|---|---|
| Use Case (e.g., | | Stress = none | | | Stress = low | | | Stress = high | | |
| application or | Latency/ | Utilization (Throughput/Capacity) | | | | | | | | |
| application | Jitter | | 0.33- | | | 0.33- | | | 0.33- | |
| type) | Sensitive | <0.33 | 0.66 | >0.66 | <0.33 | 0.66 | >0.66 | <0.33 | 0.66 | >0.66 |
| Use Case 1 | Yes | 0 | 0 | 0 | 0 | 1 | 2 | 1 | 2 | 2 |
| Use Case 2 | No | 0 | 0 | 0 | 0 | 1 | 3 | 1 | 2 | 3 |

In some implementations, the thermal mitigation can depend on whether an application being operated by the devices 110, 150 is indicated as latency/jitter sensitive. For example, given a particular value of at least one of thermal data, throughput, or capacity, the thermal manager 212 can select a first thermal mitigation responsive to the application being indicated to be a latency/jitter sensitive application and a second thermal mitigation greater than the first thermal mitigation responsive to the application being indicated to not be a latency/jitter sensitive application. For instance, in the example of Table 1, given a thermal stress=low and a utilization=0.8, the thermal manager 212 can determine the thermal mitigation to have a level of 2 responsive to the application being a latency/jitter sensitive application or can determine the thermal mitigation to have a (higher) level of 3 responsive to the application not being a latency/jitter sensitive application. This can enable the system 200 to address thermal stress while maintaining sufficient performance.

In some implementations, the devices 110, 150 may be operating in multiple use cases (e.g., operating multiple different applications). For example, the devices 110, 150 may be concurrently operating a messaging application (which may be an asynchronous application that is not latency or jitter sensitive) and a live streaming application (which may be latency or jitter sensitive). The thermal manager 212 can select the thermal mitigation to be a lower thermal mitigation as indicated for each respective use case. For example, the thermal manager 212 can identify a first thermal mitigation corresponding to a first application and a second thermal mitigation corresponding to a second thermal mitigation. The thermal manager 212 can compare the first thermal mitigation with the second thermal mitigation to select a lower (or more appropriate/effective) of the first thermal mitigation and the second thermal mitigation, and provide the lower (or more appropriate/effective) of the first thermal mitigation and the second thermal mitigation as output (e.g., to the interface controller 204).

Referring further to FIG. 2, the system 200 can include a power manager 216. The power manager 216 can be similar to the thermal manager 212, and can include one or more rules, heuristics, models, functions, mappings, algorithms, or other operators to perform operations on such as processing power data to determine power mitigations according to at least one of the power data and the application data. The power manager 216 can provide the determined thermal mitigation to the interface controller 204. The power manager 216 can determine power mitigations for operation of each particular wireless communication interface 208 (e.g., with respect to operation of cellular, WiFi, and/or Bluetooth interfaces) or links (e.g., uplink or downlink) of the wireless communication interfaces, or for various combinations of wireless communication interfaces 208.

For example, as depicted in FIG. 2, the power manager 216 can receive power data and the application data (which may be similar or identical to the application data received by the thermal manager 212). The power data can include one or more metrics of a power supply (e.g., battery) of at least one of the device 110 or the device 150. For example, the power data can include metrics such as total capacity, remaining capacity, or rate of power (e.g., energy) usage or depletion. The power data can be received to include, or the power manager 216 can determine, a power stress (e.g., battery stress) corresponding to the power data. For example, the power data can indicate power stress levels such as none, low, medium, and high (or various other classifications having greater or fewer numbers of levels). The power data can indicate whether the device 110 (and/or the device 150) are using power while in a mode of being connected to a charger or not (e.g., using battery while not connected to a charger).

The power manager 216 can determine the power mitigation in a similar manner as the thermal manager 212 determines the thermal mitigation, such as by applying one or more rules, thresholds, models, lookup tables, algorithms, heuristics, or other operations to the at least one of the application data or the power data. In some implementations, the power manager 216 determines the power mitigation by evaluating the at least one of the application data or the power data relative to one or more respective thresholds (which may be maintained in a data structure such as a lookup table). For example, the power manager 216 can select the power mitigation from a plurality of power mitigations by comparing the application data and the power data with respective thresholds to identify a particular power mitigation that matches values (or ranges of values) represented by the respective thresholds. In some implementations, the power manager 216 can determine a relatively lower power mitigation (or override or default the power mitigation to a lower or zero level) responsive to detecting that the device 110 (and/or the device 150) is connected to a charger or other external power source separate from the on-board battery.

Table 2 below provides an example of a data structure that the power manager 216 can implement to determine the power mitigation as a power mitigation level. The power mitigation level values provided in Table 2 are examples and can be configured during various processes (and at greater or less degrees of granularity), including but not limited to during manufacture, testing, calibration, before delivery to one or more end users, or after delivery to one or more end users (e.g., via on-board updating based on tracked performance data, via software or firmware updates, etc.). In the example of Table 2, higher power mitigation levels can correspond to mitigation actions that can be expected to increasingly reduce resource usage, such as to have greater effects for reducing thermal stress.

TABLE 2

| Use Case (e.g., | | Device on charger | | | Device on battery | | |
|---|---|---|---|---|---|---|---|
| application or | Latency/ | Power | Power | Power | Power | Power | Power |
| application | Jitter | Stress = | Stress = | Stress = | Stress = | Stress = | Stress = |
| type) | Sensitive | none | low | high | none | low | high |
| Use Case 1 | Yes | 0 | 0 | 0 | 0 | 1 | 2 |
| Use Case 2 | No | 0 | 0 | 0 | 1 | 2 | 3 |

Referring further to FIG. 2, the system 200 can include an interface controller 204. The interface controller 204 can include one or more rules, heuristics, models, functions, mappings, algorithms, or other operators to perform operations such as determining actions for modifying operation of the wireless communication interfaces 208, such as to reduce resource usage by the wireless communication interface 208. The interface controller 204 can be implemented by at least one of one or more processors of the device 110 or the wireless communication interface 208, such as by being at least partially implemented by firmware of the wireless communication interface 208.

As depicted in FIG. 2, the interface controller 204 can be communicably coupled with the wireless communication interface 208, the thermal manager 212, and the power manager 216. For example, the interface controller 204 can receive capacity data from the wireless communication interface 208 (e.g., from firmware of the wireless communication interface 208) to provide to the thermal manager 212; the interface controller 204 can receive the thermal mitigation determined by the thermal manager 212; the interface controller 204 can receive the power mitigation determined by the power manager 216. The interface controller 204 can receive and process various other data detected or generated by various components of the system 200.

The interface controller 204 can determine a mitigation according to at least one of the thermal mitigation or the power mitigation. In some implementations, the interface controller 204 determines the mitigation as a greater of the thermal mitigation or the power mitigation, such as by applying a maximum function to the thermal mitigation and the power mitigation. The interface controller 204 can determine the mitigation as a particular action selected from a plurality of actions. The interface controller 204 can determine the mitigation as the value of the greater of the thermal mitigation or the power mitigation, and can provide the value to the wireless communication interface 208 to cause the wireless communication interface 208 to select the particular action and modify operation in accordance with the particular action, or cause the wireless communication interface 208 to perform the particular action.

The interface controller 204 can cause mitigations (e.g., cause the wireless communication interface 208 to perform actions) that may vary with respect to expected or actual changes in operation of the wireless communication interface 208. For example, relatively greater mitigations (e.g., higher values of the mitigation, thermal mitigation, and/or power mitigation) can be performed to cause relatively greater reductions or modifications of resource usage by the wireless communication interface 208. In some implementations, the interface controller 204 can determine to cause no mitigation (e.g., responsive to the determined mitigation having a minimal or zero level), such that baseline throughput and/or power usage may be retained. In some implementations, responsive to the determined mitigation having a first level, the interface controller 204 can cause a mitigation that includes at least one of an antenna reduction (e.g., reducing number of antennas or antenna chains used), an SCC reduction, or a reduction of out of service (OOS) scans, such as to operate in an idle mode. In some implementations, responsive to the determined mitigation having a second level (e.g., indicating greater reduction in resource usage than the first level), the interface controller 204 can cause a mitigation that includes at least one of reducing bandwidth, disabling a non standalone (NSA) component, or any one or more mitigations associated with the first mitigation level. In some implementations, responsive to the determined mitigation having a third level (e.g., indicating greater reduction in resource usage than the second level), the interface controller 204 can cause a mitigation that includes at least one of reducing transmission power, any one or more mitigations associated with the first mitigation level, or any one or more mitigations associated with the second mitigation level. Any of a variety of one or more such mitigations or combinations thereof can be caused by the interface controller 204 according to factors such as expected, measured, predicted, or actual reductions in throughput and/or power, or the expected effects on heat generation (and thus temperature control) responsive to such mitigations. The interface controller 204 can include a data structure, such as a lookup table, to identify the mitigation actions to cause the wireless communication interface 208 to perform according to the determined mitigation. The data structure can be configured by the interface controller 204 (e.g., responsive to receiving data of the data structure) or a remote device coupled with the interface controller 204 during various processes (and at greater or less degrees of granularity), including but not limited to during manufacture, testing, calibration, before delivery to one or more end users, or after delivery to one or more end users (e.g., via on-board updating based on tracked performance data, via software or firmware updates, etc.).

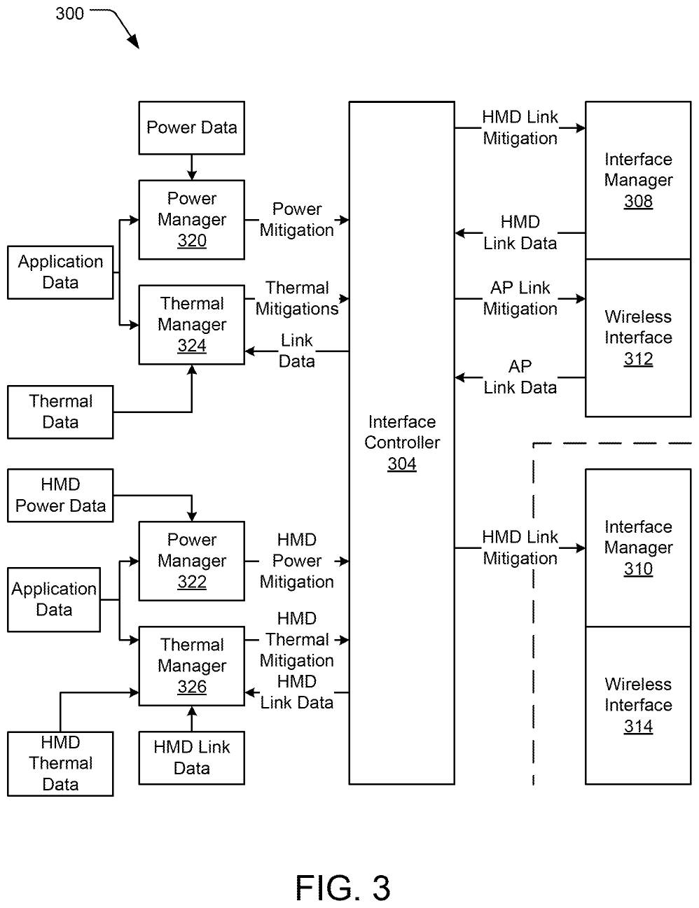

FIG. 3 is a diagram of a system 300, according to an example implementation of the present disclosure. The system 300 can incorporate features of the system 200 and/or be used to implement one or more components of the system 200. For example, various aspects of the system 300 can be used to implement interface 204, thermal manager 212, and/or power manager 216 according to particular components and communications links of the devices 110, 150, such as to provide distinct components for processing data related to and performing control of cellular and WiFi interfaces and/or specific links (e.g., uplink or downlink) between respective pairs of devices 110, 120, 150.

As depicted in FIG. 3, the system 300 can include an interface controller 304, which can be similar to the interface controller 204. The interface controller 304 can control operation of a wireless interface 312 of the device 110 and a wireless interface 314 of the device 150 (“HMD”). For example, the interface controller 304 can control operation of the wireless interfaces 312, 314, such as to cause the wireless interfaces 312, 314 to perform or modify operation in accordance with mitigations for reducing resource usage and/or reducing temperature or heat generation.

The interface controller 304 can control the wireless interfaces 312, 314 directly or using respective interface managers 308, 310. For example, the interface controller 304 may be implemented using one or more processors of the device 110 but not of the device 150 (e.g., to reduce computational demands on the device 150 to enable the device 150 to have a relatively small form factor), and can control operation of the wireless interface 312 of the device 110 directly while controlling operation of the wireless interface 312 of the device 150 via the interface manager 310. The interface managers 308, 310 can be similar to the interface controller 204, and may be implemented by at least one of one or more processors of respective devices 110, 150 or firmware of the respective wireless interfaces 312, 314. As depicted in FIG. 3, the interface controller 304 can receive HMD link data (e.g., throughput and/or capacity data) from the interface manager 308 with respect to a link between the device 110 and the device 150, and can receive AP link data (e.g., throughput and/or capacity) from the wireless interface 312 with respect to a link between the device 110 and the device 120. The interface controller 304 can provide the received HMD link data and/or AP link data to various components, such as thermal managers 324, 326.

The system 300 can include a first power manager 320 and a second power manager 322, which can be similar to the power manager 216 of the system 200. For example, the first power manage 320 can determine a power mitigation according to at least one of power data (of a power supply of the device 110) and application data (e.g., application data including at least application data of the device 110). The second power manager 322 can determine a power mitigation according to at least one of HMD power data (of a power supply of the device 150) and application data (e.g., application data including at least application data of the device 150). As such, the system 300 can facilitate determining specific power mitigations with respect to each of devices 110, 150.

The system 300 can include a first thermal manager 324 and a second thermal manager 326, which can be similar to the thermal manager 212 of the system 200. For example, the first thermal manager 324 can determine at least one thermal mitigation according to thermal data of the device 110 and at least one of application data or link data (e.g., capacity, throughput, and/or utilization) of links between the device 110 and at least one of the device 120 or the device 150. As such, the thermal manager 324 can determine multiple thermal mitigations with respect to operation of links between the device 110 and the device 120 and between the device 110 and the device 150. The second thermal manager 326 can determine at least one thermal mitigation according to HMD thermal data of the device 150 and at least one of application data and HMD link data (e.g., capacity, throughput, and/or utilization) of links between the device 110 and the device 120. As such, the system 300 can use the second thermal manager 326 to determine thermal mitigations specific to links between the device 110 and the device 150.

Referring further to FIG. 3, the interface controller 304 can receive mitigation data including at least one of the power mitigation from the power manager 320, the thermal mitigation(s) from the thermal manager 324, the power mitigation from the power manager 322, and the thermal mitigation from the thermal manager 326. The interface controller 304 can determine one or more mitigations to cause/perform/execute with respect to at least one of the wireless interface 312 or the wireless interface 314 according to the received mitigation data. For example, the interface controller 304 can determine, according to the at least one of the power mitigation from the power manager 320, the thermal mitigation(s) from the thermal manager 324, the power mitigation from the power manager 322, and the thermal mitigation from the thermal manager 326, at least one of (i) an HMD link mitigation for operation of the wireless interface 312 of the device 110 with respect to link(s) between the device 110 and the device 150; (ii) an AP link mitigation for operation of the wireless interface 312 with respect to link(s) between the device 110 and the device 120 (e.g., where the device 120 is an access point); or (iii) an HMD link mitigation for operation of the wireless interface 314 of the device 150 with respect to link(s) between the device 110 and the device 150. The interface controller 304 can determine the one or more mitigations in a similar manner as the interface controller 204, including but not limited to by evaluating one or more data structures (e.g., lookup tables analogous to Table 1 and/or Table 2), rules, heuristics, models, algorithms, functions, or other operations according to the received mitigation data or a subset of the received mitigation data. The interface controller 304 can individually determine respective mitigations (e.g., HMD link mitigation for wireless interface 312, AP link mitigation for wireless interface 312, HMD link mitigation for wireless interface 314) according to the same or different operations (e.g., using the same or different lookup tables). The interface controller 304 can determine similar actions for mitigations according to the received mitigation data as determined by the interface controller 204.

In some implementations, responsive to determining to perform at least some mitigation of the operation of the wireless interface 312, the interface controller 304 does not determine to cause mitigation of the operation of the wireless interface 314 unless the HMD thermal data meets or exceeds a particular threshold. For example, the interface controller 304 may cause mitigations to wireless interface 312 for communication with the device 120 without mitigation communication between the device 110 and the device 150. The interface controller 304 can determine at least one mitigation to prioritize performance of the device 150, such as to assign a highest priority to operation of the wireless interface 314 for communication with the wireless interface 312, then to operation of the wireless interface 312 for communication with the wireless interface 314, then to operation of the wireless interface 312 for communication with the device 120, so that resulting effects/degradation on a user experience provided via the device 150 are avoided or minimized.

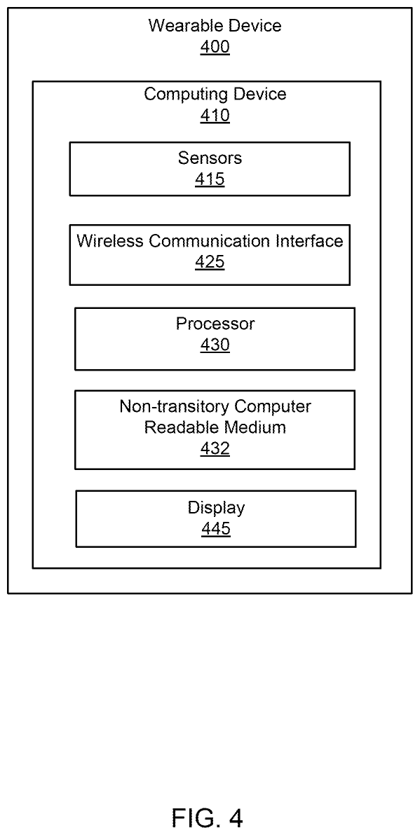

FIG. 4 is a diagram of a wearable device 400, according to an example implementation of the present disclosure. In some implementations, the wearable device 400 may be the wearable device 110 or the wearable device 150. In some implementations, the wearable device 400 includes a computing device 410 and a cradle (not shown in FIG. 4), to which the computing device 410 can be selectively attached. In some implementations, the computing device 410 includes sensors 415, wireless communication interfaces 425 (also referred to as “wireless interfaces 425” herein), processor 430, non-transitory computer readable medium 432, and a display 445. These components may operate together to communicate with another device, and generate or render content (e.g., artificial reality content). In other implementations, the wearable device 400 includes more, fewer, or different components than shown in FIG. 4.

In some implementations, the sensors 415 include electronic components or a combination of electronic components and software components that detect a proximity of a user wearing the wearable device 400. For example, the sensors 415 can include a hall sensor that can detect whether the user is proximate (e.g., less than 10 mm) to the sensor or whether the user is contacting the computing device 410 (e.g., contacting and/or blocking a certain component of the device used/configured for wireless communication). The sensors 415 may detect a proximity of the user with respect to the computing device 410, and can generate a sensor measurement data indicating the detected proximity.

In some implementations, the sensors 415 include electronic components or a combination of electronic components and software components that can operate to sense/determine/measure a location and/or an orientation of the computing device 410. Examples of the sensors 455 can include: one or more imaging sensors, one or more accelerometers, one or more gyroscopes, one or more magnetometers, or any other suitable type of sensor(s) that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 415 detect the translational movement and the rotational movement, and determine an orientation and location of the computing device 410. The sensors 415 may generate sensor measurements indicating the detected location and orientation of the computing device 410.

In some implementations, wireless communication interfaces 425 include electronic components or combinations of electronic components and software components that communicate with another device through wireless communication links (e.g., communication link 114, 116, 118). In some implementations, the wireless communication interfaces 425 include a wireless interface for a cellular communication link (e.g., 3G, 4G, LTE communication link). The wireless communication interfaces 425 may also include a wireless interface for a different communication link (e.g., Wi-Fi or Bluetooth communication link). In some implementations, wireless communication interfaces 425 include or are embodied as transceivers or communication modems coupled to the transceivers for transmitting and receiving data through wireless mediums. The wireless communication interfaces 425 may transmit or receive sensor measurement data indicating locations and orientations of the computing device 410. Moreover, the wireless communication interface 425 may transmit or receive image data indicating or corresponding to images to be rendered.

In some implementations, the processor 430 includes an electronic component or a combination of an electronic component that can execute instructions stored by the non-transitory computer readable medium 432. The processor 430 may include one or more central processing units (CPUs), graphical processing units (GPUs) or a combination of them. The non-transitory computer readable medium 432 may store instructions for executing one or more applications executable by the processor 430.

One example application when executed by the processor 430 may cause the processor 430 to generate or process content for rendering. The processor 430 executing the application may cause the processor 430 to generate image data for rendering, according to sensor measurement data from the sensors 415 or the wireless communication interfaces 425. For example, the processor 430 executing the application may determine a view of the artificial reality corresponding to detected location and orientation in the sensor measurement data and generate image data of the determined view of the artificial reality.

Example applications when executed by the processor 430 may cause the processor 430 to control or adjust the wireless communication interface 425. Example applications include wireless interface controller 434.

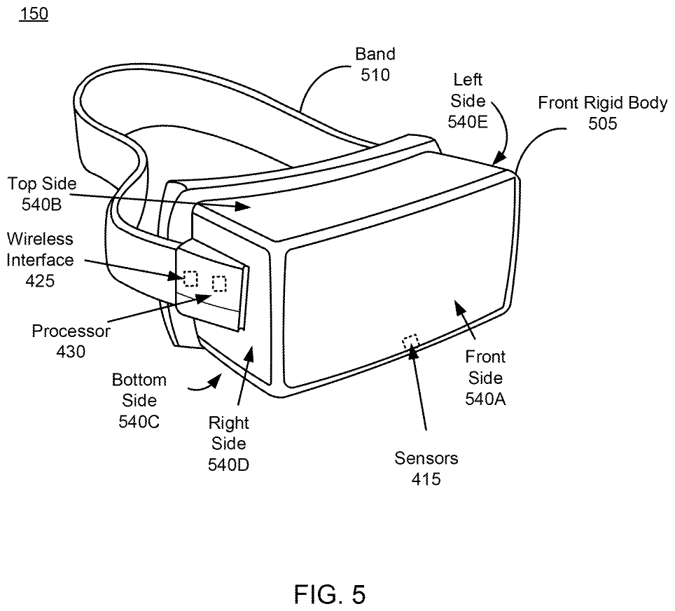

FIG. 5 is a diagram of the HWD 150, in accordance with an example implementation. In some implementations, the HWD 150 includes a front rigid body 505 and a band 510. The front rigid body 505 includes the display 445 (not shown in FIG. 5), lens (not shown in FIG. 5), the sensors 415, the wireless communication interface 425, and the processor 430. In the implementation shown by FIG. 5, the wireless communication interface 425, the processor 430, and the sensors 415 are located within the front rigid body 405, and may not be visible to the user. In other implementations, the HWD 150 has a different configuration than shown in FIG. 5. For example, the wireless communication interface 425, the processor 430, and/or the sensors 415 may be in different locations than shown in FIG. 5.

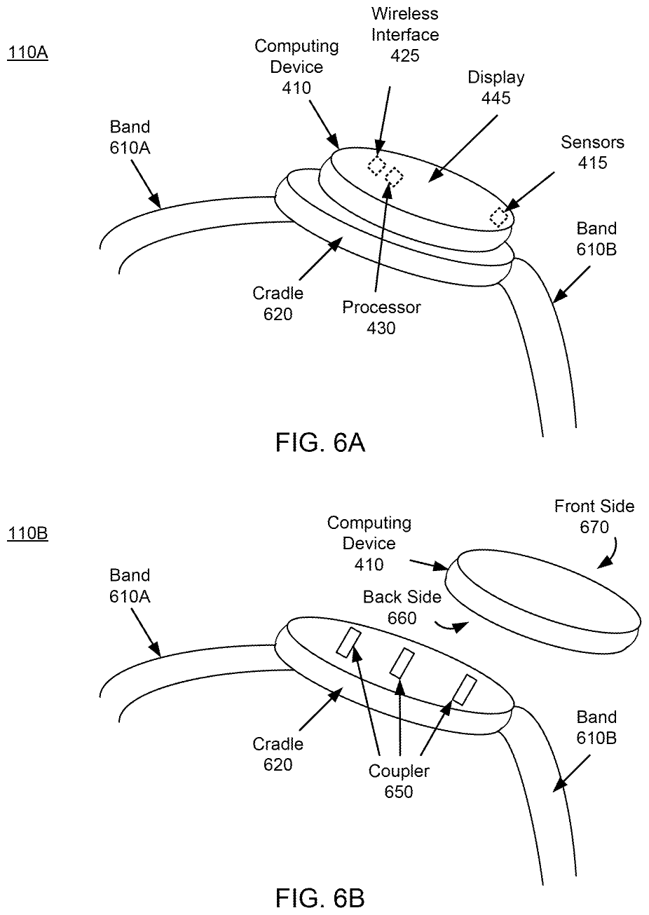

FIG. 6A is a diagram showing a perspective view of the wearable device 110A (e.g., wearable device 110 in a state 110A) including a computing device 410 attached to a cradle 620, according to an example implementation of the present disclosure. The processor 430, the wireless communication interface 425 and the sensors 415 may be disposed within a housing of the computing device 410, such that the processor 430, the wireless communication interface 425 and the sensors 415 may not be visible to the user. The computing device 410 may also include the display 445 on a front side 670 to present text or image. The computing device 410 may be detachable from the cradle 620 as shown in FIG. 6B (e.g., wearable device 110 in state 110B). The computing device 610 may be detached from the cradle 620 to allow the user to charge the battery of the computing device 610, connect to another device through a cable, or capture an image, etc. The cradle 620 may be a wearable structure or a component to selectively hold, contain, connect, grasp and/or couple the computing device 410. The cradle 620 may include one or more couplers 650, to which a back side 660 or other portion of the computing device 210 can be attached. One or more couplers 650 may include mechanical latches, magnetics, hook and loop fasteners, or any component(s) that allow the cradle 620 to selectively hold or couple the computing device 410. The cradle 620 may include or may be attached to wrist bands 610A, 620B.

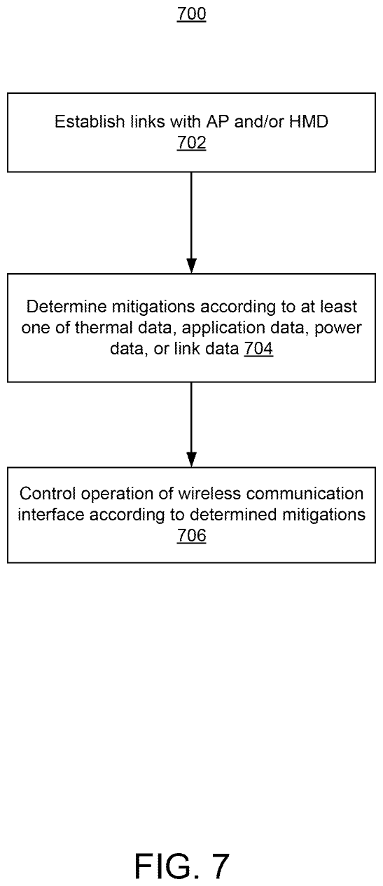

FIG. 7 shows a block diagram of a representative method 700 for thermal management. In some implementations, the method 700 can be implemented by one or more processors of at least one device, such as a compute device and a display device coupled with the compute device. In brief overview, the method can include establishing 702, using at least one wireless interface, at least one link between a device and at least one of an HMD (e.g., second device) or an access point. The method can include determining 704 at least one mitigation to apply to operation of the at least one wireless interface according to data regarding operation of the device, the HMD, and/or the links. The method can include controlling 706 operation of the at least one wireless interface according to the at least one mitigation. In some embodiments, the method 700 can be performed by the wearable device 110 or the wearable device 150. In some embodiments, the method 700 can be performed by other entities. In some embodiments, the method 700 includes more, fewer, or different steps than shown in FIG. 7.

Referring to FIG. 7, and in further detail, the wireless communication interface can establish 702 one or more links (e.g., wireless communication links) with at least one of an access point or an HMD. For example, the wireless communication interface can be an interface of a compute device, such as a console or wearable device, that performs at least some processing of data from at least one of the access point or the HMD to provide data to the HMD for presentation by the HMD. The links can include, for example, WiFi, cellular, and/or Bluetooth links. In some implementations, establishing the links includes establishing one or more first WiFi links with the access point and one or more second WiFi links with the HMD.

One or more processors of at least one of the device or the HMD can determine 704, according to data of the at least one of the device or the HMD, one or more mitigations to apply to operation of the at least one of the device or the HMD (e.g., to apply to one or more wireless interfaces of the at least one of the device or the HMD). The data can include, for example, thermal data, such as temperature data; application data, such as data indicating which applications are operating or communicating, as well as indications of performance criteria of the applications, such as whether the applications are sensitive to latency or jitter; power data, such as remaining power or capacity, total capacity, health, or power usage state (e.g., on charger vs. on battery) of power supplies (e.g., batteries); and/or link data, such as throughput, capacity, and/or utilization of one or more links between the device, the HMD, and/or the access point. The one or more processors can receive or request the data (or subsets thereof) synchronously or asynchronously. The one or more processors can receive or request the data responsive to a condition being met, such as activation of a device, changing in operating state of the device (e.g., waking from sleep), activation of an application, detection of network packets from an application, establishment of the links, according to a schedule, or various combinations thereof. The determined mitigations can be specific to each link (e.g., each link direction) of communication between the device and access point or device and HMD, respectively. For example, a first mitigation can be determined for operation of the wireless interface of the device for communication between the device and the access point, a second mitigation can be determined for operation of the wireless interface of the device for communication between the device and the HMD, and a third mitigation can be determined for operation of the wireless interface of the HMD for communication between the HMD and the device; each of the first, second, and third mitigations can be similar or different, depending on factors such as prioritizing performance of particular components or applications, such as to prioritize performance of the HMD or prioritizing performance of latency/jitter sensitive applications.

The one or more processors can control 706 operation of at least one of the wireless interface(s) of the device or the wireless interface(s) of the HMD according to the determined mitigations. For example, the one or more processors can cause the wireless interface(s) to perform actions or modify operations, including but not limited to, by modifying bandwidth, modifying transmission power, modifying transmission time (e.g., relative to other communications being performed), modifying the number of antennas or antenna chains in operation, operating in an SCC only mode, reducing OOS scans, or disabling NSA. The one or more processors can cause the specific mitigations for specific links. The one or more processors can periodically or iteratively (re-)evaluate the data (e.g., the thermal data, power data, application data, and/or capacity/throughput/utilization data) and can modify the mitigations responsive to the (re-)evaluation.

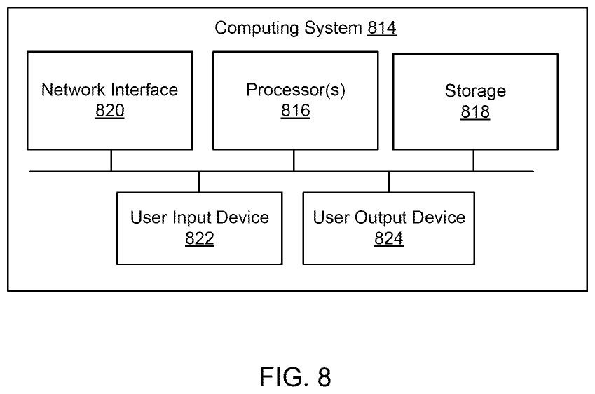

Various operations described herein can be implemented on computer systems. FIG. 8 shows a block diagram of a representative computing system 814 usable to implement implementations of the present disclosure. In some implementations, the wearable device 110 of FIG. 1 is implemented by the computing system 814. The computing system 814 can be implemented, for example, as a consumer device such as a smartphone, other mobile phone, tablet computer, wearable computing device (e.g., a smart watch, eyeglasses, a head wearable display), desktop computer, laptop computer, or implemented with distributed computing devices. The computing system 814 can be implemented to provide VR, AR, MR experience. In some implementations, the computing system 814 can include conventional computer components such as processors 816, storage device 818, network interface 820, user input device 822, and user output device 824.

The network interface 820 can provide a connection to a wide area network (e.g., the Internet) to which WAN interface of a remote server system is also connected. The network interface 820 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The user input device 822 can include any device (or devices) via which a user can provide signals to the computing system 814, which can interpret the signals as indicative of particular user requests or information. The user input device 822 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

The user output device 824 can include any device via which the computing system 814 can provide information to a user. For example, the user output device 824 can include a display (not depicted) to display images generated by or delivered to the computing system 814. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that functions as both input and output device can be used. The user output devices 824 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this disclosure can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processors 816 can provide various functionality for the computing system 814, including any of the functionality described herein as being performed by a server or client, or other functionality associated with message management services.

It will be appreciated that the computing system 814 is illustrative and that variations and modifications are possible. Computer systems used in connection with the present disclosure can have other capabilities not specifically described here. Further, while the computing system 814 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device, comprising:
at least one wireless communication interface configured to establish at least one of (i) a first link with a first remote device or (ii) a second link with a second remote device; and
one or more processors configured to:
control operation of the at least one wireless communication interface according to:
(i) temperature data of at least one of the device or the first remote device; and
(ii) at least one of (a) power data of at least one of the first device or the second device or (b) at least one of capacity or throughput of at least one of the first link or the second link.

2. The device of claim 1, wherein the one or more processors are configured to control operation of the at least one wireless communication interface according to application data of one or more applications that transmit or receive data packets for communication over the at least one of the first link or the second link.

3. The device of claim 1, wherein the one or more processors are configured to control operation of the at least one wireless communication interface by:
determining a thermal state of at least one of the device or the first remote device, according to the temperature data and the at least one of capacity or throughput of the at least one of the first link or the second link; and
determining an adjustment to operation of the at least one wireless communication interface responsive to evaluating a mitigation criteria according to the thermal state.

4. The device of claim 1, wherein the one or more processors are configured to control the operation of the at least one wireless communication interface by reducing resource usage of the at least one wireless communication interface.

5. The device of claim 4, wherein the reduction of resource usage corresponds to a reduction of at least one of power usage or throughput.

6. The device of claim 1, wherein the first remote device comprises a display device, and the second remote device comprises a network access point.

7. The device of claim 1, wherein the one or more processors are configured to control operation of the at least one wireless communication interface by:
selecting, from a data structure associating a plurality of mitigation states with values of data, a particular mitigation state of the plurality of mitigation states according to (i) the temperature data and (ii) the at least one of (a) the power data or (b) the at least one of capacity or throughput; and
reducing resource usage of the at least one wireless communication interface according to the selected mitigation state.

8. A method, comprising:
establishing, by at least one wireless communication interface, at least one of (i) a first link with a first remote device or (ii) a second link with a second remote device; and
controlling, by one or more processors, operation of the at least one wireless communication interface according to:
(i) temperature data of at least one of the device or the first remote device; and
(ii) at least one of (a) power data of at least one of the first device or the second device or (b) at least one of capacity or throughput of at least one of the first link or the second link.

9. The method of claim 8, further comprising controlling, by the one or more processors, operation of the at least one wireless communication interface according to application data of one or more applications that transmit or receive data packets for communication over the at least one of the first link or the second link.

10. The method of claim 8, wherein controlling the operation of the at least one wireless communication interface comprises:
determining a thermal state of at least one of the device or the first remote device, according to the temperature data and the at least one of capacity or throughput of the at least one of the first link or the second link; and
determining an adjustment to operation of the at least one wireless communication interface responsive to evaluating a mitigation criteria according to the thermal state.

11. The method of claim 8, further comprising controlling, by the one or more processors, operation of the at least one wireless communication interface by reducing resource usage of the at least one wireless communication interface.

12. The method of claim 11, wherein the reduction of resource usage corresponds to a reduction of at least one of power usage or throughput.

13. The method of claim 8, wherein the first remote device comprises a display device, and the second remote device comprises a network access point.

14. The method of claim 8, wherein controlling the operation of the at least one wireless communication interface comprises:
selecting, from a data structure associating a plurality of mitigation states with values of data, a particular mitigation state of the plurality of mitigation states according to (i) the temperature data and (ii) the at least one of (a) the power data or (b) the at least one of capacity or throughput; and
reducing resource usage of the at least one wireless communication interface according to the selected mitigation state.

15. A non-transitory computer readable medium storing instructions when executed by one or more processors of a device, cause the one or more processors to:
control operation of at least one wireless communication interface, the at least one wireless communication interface operating at least one of (i) a first link with a first remote device or (ii) a second link with a second remote device, the control performed according to:
(i) temperature data of at least one of the device or first remote device; and
(ii) at least one of (a) power data of at least one of the first device or the second device or (b) at least one of capacity or throughput of at least one of the first link or the second link.

16. The non-transitory compute readable medium of claim 15, wherein the reduction of resource usage corresponds to a reduction of at least one of power usage or throughput.

17. The non-transitory compute readable medium of claim 16, wherein the first remote device comprises a display device, and the second remote device comprises a network access point.

18. The non-transitory compute readable medium of claim 15, further comprising instructions to cause the one or more processors to control operation of the at least one wireless communication interface according to application data of one or more applications that transmit or receive data packets for communication over the at least one of the first link or the second link.

19. The non-transitory computer readable medium of claim 15, further comprising instructions to cause the one or more processors to control the operation of the at least one wireless communication interface by reducing resource usage of the at least one wireless communication interface.

20. The non-transitory computer-readable medium of claim 15, further comprising instructions to cause the one or more processors to control operation of the at least one wireless communication interface by:
selecting, from a data structure associating a plurality of mitigation states with values of data, a particular mitigation state of the plurality of mitigation states according to (i) the temperature data, and (ii) the at least one of (a) the power data or (b) the at least one of capacity or throughput; and
reducing resource usage of the at least one wireless communication interface according to the selected mitigation state.
